(19) United States
(12) Patent Application Publication
(10) Pub. No.: US 2015/0372326 A1
(43) Pub. Date: Dec. 24, 2015

(54) Fuel Cell System

(71) Applicant: Bayerische Motoren Werke Aktiengesellschaft, Muenchen (DE)

(72) Inventors: Roman HIEMER, Muenchen (DE); Stefan HAASE, Muenchen (DE)

(21) Appl. No.: 14/835,865

(22) Filed: Aug. 26, 2015

Related U.S. Application Data
(63) Continuation of application No. PCT/EP2014/051444, filed on Jan. 24, 2014.

(30) Foreign Application Priority Data
Feb. 27, 2013 (DE) 10 2013 203 317.6

(51) Int. Cl. H01M 8/04; B60L 11/18

(52) U.S. Cl. CPC H01M 8/04052; B60L 11/1883; B60L 11/1888; H01M 2250/20

(57) ABSTRACT

A fuel cell system is provided having multiple individual fuel cells which are combined to form a fuel cell stack, and having two current collectors which adjoin the two end-side individual fuel cells. The current collectors are each adjoined directly, or with the interposition of an isolation plate, by an end plate. A heat accumulator is provided at least on one of the current collectors so as to adjoin that side of the latter which faces away from the individual fuel cells. The heat accumulator may be arranged in a recess of the end plate, or of an optionally provided isolation plate, and a compensation reservoir for a change in volume of the heat accumulator may be provided.

### CROSS REFERENCE TO RELATED APPLICATIONS

This application is a continuation of PCT International Application No. PCT/EP2014/051444, filed Jan. 24, 2014, which claims priority under 35 U.S.C. §119 from German Patent Application No. 10 2013 203 317.6, filed Feb. 27, 2013, the entire disclosures of which are herein expressly incorporated by reference.

### BACKGROUND AND SUMMARY OF THE INVENTION

The present invention relates to a fuel cell system having multiple individual fuel cells combined to form a fuel cell stack, and having two current collectors which adjoin the two end-side individual fuel cells, which current collectors are each adjoined directly, or with the interposition of an isolation plate, by an end plate.

Individual fuel cells are generally connected in series to form a fuel cell stack (hereinafter also referred to as a stack) in order to realize a higher electrical voltage. On each end of a fuel cell stack there is situated an end plate, which end plates exert a uniform contact pressure on the individual fuel cells and brace these to form a fuel cell stack, and thus also ensure that the various fluid flows conducted in the fuel cell stack are reliably separated from one another, and ensure leak-tightness with respect to the outside. Between the end plates and the stack of individual fuel cells there is situated in each case one current collector (normally composed of copper) which collects the electrical current of all of the individual fuel cells and conducts it away from the fuel cell stack. Normally, the current collector is separated from the adjacent end plate by way of an isolation layer which electrically and thermally isolates the current collector with respect to the end plate, in particular if the end plate is not composed of an electrical isolation material.

A conventional PEM fuel cell (low-temperature proton exchange membrane fuel cell) has an ideal operating temperature of between 60 and 80° C. If the temperature at which the chemical reaction in the individual fuel cells is started lies far below this, the power of the entire fuel cell stack decreases significantly. In order to attain acceptable power values quickly, it is therefore necessary for the temperature of the individual fuel cells to be raised as rapidly as possible in the event of a cold start. The thermal mass of the bipolar plates provided in a fuel cell and of the membrane-electrodes unit is low, whereby the individual fuel cells themselves can in fact be heated up relatively quickly. However, the current collectors at the end of the fuel cell stack have a very high thermal mass or heat capacity, such that a greater level of heat energy or amount of heat is necessary to heat these up.

In the prior art, the thermal energy for heating the current collector is imparted by the individual fuel cells that bear directly against the current collector and by a small number of individual fuel cells adjacent to the former individual fuel cells, whereby the individual fuel cells situated in the end regions of the fuel cell stack likewise themselves heat up only slowly, as there is a direct link between the current flow via the current collector and the heat capacity of the current collector. Owing to the series connection of the individual fuel cells, the low power capacity, resulting from the slow heating, of the (relatively few) individual fuel cells in the end regions of the stack however has an adverse effect on the electricity generation balance of the fuel cell stack as a whole. Thus, the electrical power that can be obtained during a cold start of the fuel cell stack reaches an acceptable level only after a few minutes. This long start-up time is undesirable in the case of a mobile application—for example in a motor vehicle.

U.S. 2010/0248058 A1, DE 10 2004 013 256 A1 and DE 103 37 898 A1 do not present the latent heat accumulator arrangement disclosed here. Taking this prior art as a starting point, it is therefore an object of the present invention to provide a fuel cell system of the type mentioned in the introduction which, with simple means, can be heated relatively quickly to an expedient operating temperature.

This and other objects are achieved, in the case of a fuel cell system having multiple individual fuel cells which are combined to form a fuel cell stack, and having two current collectors which adjoin the two end-side individual fuel cells, which current collectors are each adjoined directly, or with the interposition of an isolation plate, by an end plate, in that a heat accumulator is provided on at least one of the current collectors so as to adjoin that side of the latter which faces away from the individual fuel cells.

Owing to the configuration according to the invention, the fuel cell system can, in the event of a cold start, with a release of heat from a heat accumulator to the one or more current collectors, be heated quickly to an expedient operating temperature with relatively simple means and with high efficiency. This can be done if the thermal energy which is stored during prior operation of the fuel cell system in the heat accumulator, provided according to the invention, of the stack, which thermal energy is in effect excess thermal energy and is generated during the operation by the energy conversion process taking place in the individual fuel cells, can, after a shutdown of the stack and after the latter has cooled down, be released from the heat accumulator in particular to the current collector upon a subsequent start and thus contribute to accelerated heating of the current collector. The release of heat from the heat accumulator is preferably performed in controlled fashion, whereas the charging of the heat accumulator may take place automatically. It is particularly advantageous here if each of the two current collectors is assigned a heat accumulator.

In a refinement of the invention, the heat accumulator may be arranged in a recess of the end plate, which is normally already suitably dimensioned for this purpose. Heat losses of the heat accumulator can be kept particularly low if the heat accumulator is arranged in a recess of an isolation plate which is arranged between the end plate and the current collector.

If the heat accumulator undergoes system-induced changes in volume during the heat absorption process and heat release process, it is possible, in a further embodiment, for a suitable compensation reservoir to be provided for such changes in volume of the heat accumulator. The compensation reservoir may advantageously be formed by a fibrous structure or foamed structure which may also be situated in intermediate spaces of the heat accumulator.

The heat accumulator advantageously has a material which is present in a metastable state in a suitable temperature range and which is caused by a triggering mechanism to crystallize, such as for example salt hydrates, paraffins or sugar alcohols. Use is thus preferably made of a latent heat accumulator, although alternatives to these are also possible, such as thermochemical accumulators or sorption accumulators and the like.

As regards the triggering of such accumulators, that is to say the activation thereof for the release of stored heat, this may be realized by way of a wide variety of suitable mechanisms known to a person skilled in the art. One example for such release mechanisms may utilize, for example, the principle of the so-called “cold finger” (a laboratory equipment part for generating a cooled surface), whereby a supply of cold into the accumulator material causes the heat accumulator to be triggered. For example, for this purpose, a small amount of supercooled hydrogen which is stored in a cryogenic tank or the like for supply to the fuel cell system may be utilized for triggering the heat accumulator, that is to say, when a cold start of the fuel cell system is intended, said hydrogen may be conducted in targeted fashion through the heat accumulator, or the cold of hydrogen extracted from the cryogenic tank or the like may be coupled, that is to say partially transmitted, to the heat accumulator in some other suitable way. Alternatively, a targeted variation of a flow cross section, for example in a hydrogen feed line to the stack, may be used as a triggering means for the (latent) heat accumulator because, as is known, fluids change their temperature in a manner dependent on their flow through certain lines, such that, by way of a targeted cross-sectional variation, cooling of the line can be effected, which is then used as a triggering mechanism for the latent heat accumulator, in particular by virtue of the line or a corresponding line branch being led through the heat accumulator. This principle is self-evidently not restricted to the use of hydrogen as fluid for this purpose.

A further example for a triggering principle of said type by means of quasi-supercooling of the heat accumulator is the discharging of a small hydrogen metal hydride accumulator which is in thermal contact with the latent heat accumulator. Here, by use of a valve, the pressure of the hydrogen in the metal hydride accumulator can be dissipated, whereby cold is generated in/at the metal hydride accumulator, which cold in turn is supplied for example via a suitable heat conductor to the latent heat accumulator for the triggering thereof.

Further examples for possible triggering mechanisms for heat accumulators, in particular latent heat accumulators, include a so-called “clicker” (snap disk or similar metal plate that can assume different forms); alternatively, for example, triggering is also possible by way of ultrasound or by way of an electrically charged Peltier element. Using such triggering mechanisms or other suitable triggering mechanisms, it is possible for the heat accumulator to be targetedly activated upon a cold start of the fuel cell system, such that the heat accumulator releases to the current collector the heat that has been stored during prior operation of the fuel cell system.

The above-discussed solution according to the invention yields the following advantages: the ideal power of the fuel cell stack is attained much more quickly. The temperature at which a cold start can be performed at all is much lower than in the case of a fuel cell stack without a heat accumulator of this type. The individual fuel cells, in particular the outer individual fuel cells, have a longer service life, as formation of ice in the pores of the membranes thereof is reduced owing to the more rapid temperature increase. Specifically, possibly frozen water molecules could, owing to their increase in volume upon transition from the liquid state into the frozen state, at least partially destroy the structure of the membrane, whereby the conductivity of the membrane would be greatly reduced.

In a further possible refinement of the present invention, the one or more heat accumulators, for example latent heat accumulators, may be segmented so as to be divided into multiple, at least two, sub-units, each of which can be individually triggered by means of a triggering mechanism. The triggering of the various accumulator units is preferably performed at different points in time. Thus, the heating process of the respective current collector can be controlled in targeted fashion. The thermal power of the individual sub-units of the one or more heat accumulators may differ from one another to such an extent that the amount of heat released to the respective current collector or to the individual fuel cells adjacent thereto can be set in targeted fashion.

Furthermore, it is also possible here for different types of heat accumulators to be provided in combination with one another, because in this way, too, it is possible to reproduce the release of different levels of thermal power in different regions of the current collector and/or different triggering temperatures for the superposition of the respective temperature gradient. It is thus possible to realize different triggering times, in particular triggering temperatures, different amounts of heat released, etc., in order that, during a starting process of the fuel cell system, in the presence of different present actual temperatures in the stack, the best possible heating strategy in each case can be reproduced. Here, it should preferably be sought to reproduce the warm-up behavior of an individual fuel cell situated in the middle of the stack.

Furthermore, in addition to a heat accumulator provided according to the invention, there may also be provided another further targetedly activatable heat source for the fuel cell stack and, in particular, for the one or more current collectors thereof. For example, there may additionally be provided an electrical heating line, or an, as it were, additionally activatable heat source may be formed by a heat pump or else by a metal hydride accumulator.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a cross section view through a fuel cell stack designed according to an embodiment of the invention;

FIG. 2 is a voltage diagram of a fuel cell stack according to the prior art, without a heat accumulator; and

FIG. 3 is a voltage diagram of a fuel cell stack according to an embodiment of the invention with a heat accumulator.

### DETAILED DESCRIPTION OF THE DRAWINGS

Here, the figures show only those parts of the fuel cell system which are of interest; for clarity, all other elements have been omitted.

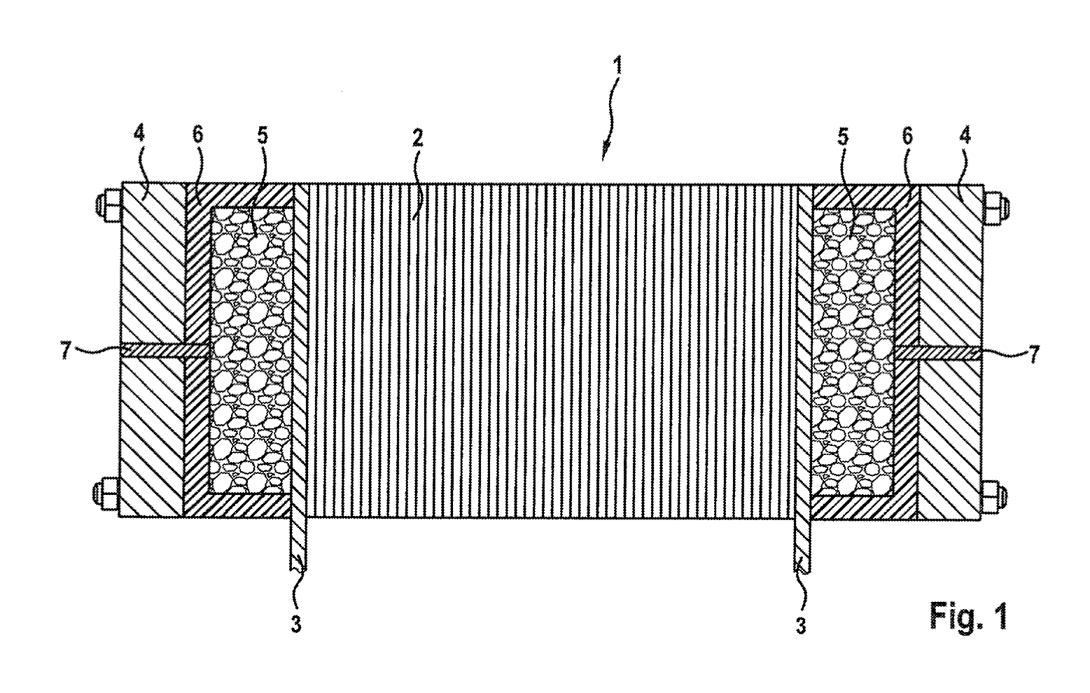

As per FIG. 1, the fuel cell system is composed of multiple individual fuel cells 2 which are combined (and in the process stacked one on top of the other) to form a fuel cell stack 1 or stack 1. The stack of individual fuel cells 2 is delimited at each end by a current collector 3, on whose side facing away from the individual fuel cells 2 there is provided an end plate 4. In the present case, an isolation plate 6 is also provided between the respective current collector 3 and the respective end plate 4.

Furthermore, a heat accumulator 5 is situated on the current collector 3 on the side facing away from the individual fuel cells 2. The heat accumulator 5 is, in this case, arranged in a recess of the isolation plate 6. The heat accumulator 5 is in the form of a latent heat accumulator (with phase change material PCM) or may be in the form of a sorption accumulator (for example with zeolite). Alternatively—in a manner which is however not illustrated—the heat accumulator 5 may also be arranged in a recess of the end plate 4. Since, depending on the material used or construction, the heat accumulator 5 may undergo a change in volume during an absorption or release of heat, a compensation reservoir (not shown) for a change in volume of the heat accumulator 5 may be provided. The compensation reservoir is advantageously formed by a fibrous or foamed structure which is situated in intermediate spaces of the heat accumulator 5.

A suitable triggering mechanism 7, illustrated here merely in abstract form, by which a release of heat from the heat accumulator can be initiated in controlled fashion, for example through the triggering of a crystallization of the material in the heat accumulator 5 and thus a release of the heat previously stored and contained in the heat accumulator, may be led through the isolation plate 6 and through the end plate 4, and may function in accordance with one or more of the principles discussed above, or in some other way.

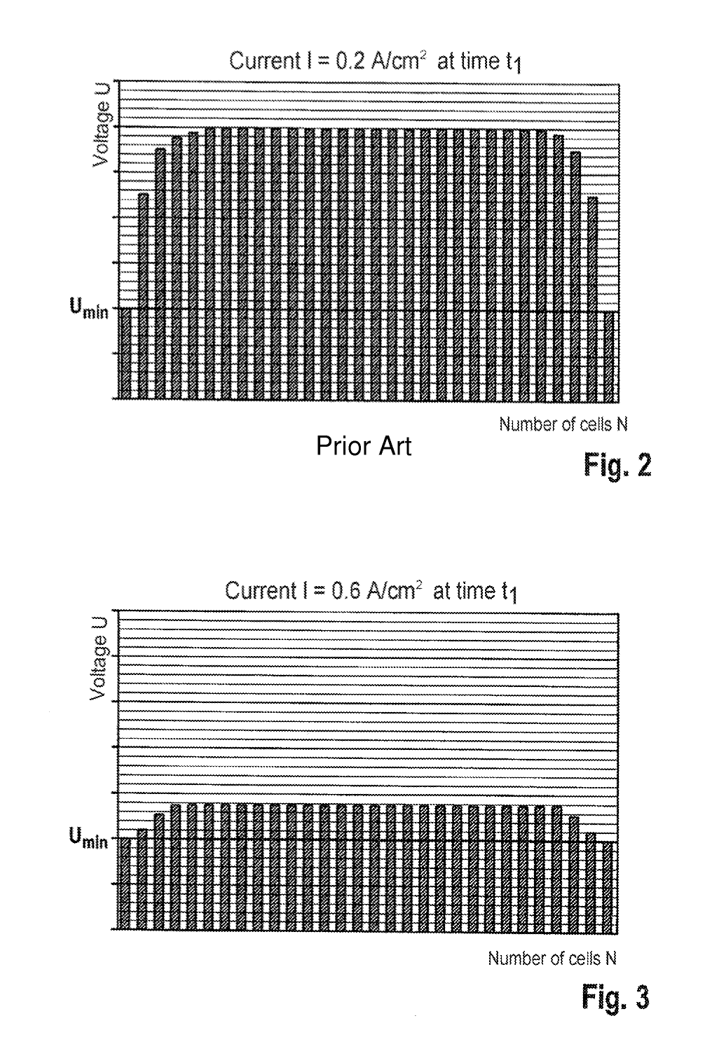

FIG. 2 shows an electrical voltage diagram of a fuel cell system without the provision of a heat accumulator according to the invention, at a time t₁ shortly after a cold start of the fuel cell system. On the abscissa, the respective individual fuel cells (2) (“number of cells N”) are indicated as bars, whose electrical voltage value (“voltage U”) when an electrical current of 0.2 amperes per unit of area (cm²) is drawn from the respective individual fuel cell is plotted in the form of the height of the respective bar on the ordinate. It can be seen here that the two outer individual fuel cells, specifically the individual fuel cell furthest to the left in the voltage diagram and the individual fuel cell situated furthest to the right in the voltage diagram, have a considerably lower electrical voltage than the individual fuel cells situated between the two individual fuel cells. The level or magnitude of the total electrical current provided by or drawn from the fuel cell stack is however, in a known manner, always adapted to the individual fuel cell with the lowest voltage level, with the decisive factor being a minimum electrical voltage Uₘᵢₙ which must not be undershot in order that the fuel cell stack as far as possible does not approach a state which is critical with regard to service life. It is thus evident that, here, the two outermost individual fuel cells constitute the limiting factor of the fuel cell stack as a whole, whereas the relatively high electrical voltage in the middle individual fuel cells remains, in effect, unutilized.

FIG. 3 shows a similar voltage diagram for the otherwise identical fuel cell stack, but in this case with a heat accumulator 5 according to the invention provided at each current collector 3. In this case, too, the fuel cell stack has been started from cold, and it can be seen that, at the same point in time t₁, the differences in electrical voltage U between the two outer individual fuel cells and the middle individual fuel cells arranged in between are considerably smaller. It is thus possible for a greater electrical current to be picked off per unit of area of each individual fuel cell, in this case 0.6 A/cm². Thus, the electrical power of the fuel cell stack with the heat accumulator 5 according to the invention in the start-up phase of the fuel cell stack is three times that of the otherwise identical fuel cell stack without a heat accumulator. Since, in the case of the fuel cell stack equipped according to the invention with at least one, preferably two heat accumulators 5, the current collectors 3 of which fuel cell stack are heated by the respective heat accumulator 5 in the event of a cold start, more heat is generated in the form of heat losses in the middle individual fuel cells 2 during the start-up phase of the fuel cell system than in the case of an otherwise identical fuel cell system without heat accumulator. The waste heat of the middle individual fuel cells 2 makes a crucial contribution to a faster warm-up process of the fuel cell stack. The faster warm-up process takes place up to 5 times as quickly as the warm-up process in the case of an identical fuel cell stack without a heat accumulator provided according to the invention. The fuel cell system described above may in this case preferably be used in a motor vehicle.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A fuel cell system, comprising:
multiple individual fuel cells combined to form a fuel cell stack;
two current collectors, each of which adjoins a respective end-side one of the individual fuel cells;
two end plates, each end plate adjoining a respective current collector; and
a heat accumulator provided on at least one of the current collectors so as to adjoin a side of the one current collector which faces away from the individual fuel cell.

2. The fuel cell system according to claim 1, further comprising:
isolation plates, each isolation plate being interposed between a respective current collector and the end plate.

3. The fuel cell system according to claim 1, wherein the heat accumulator is arranged in a recess of the end plate.

4. The fuel cell system according to claim 2, wherein the heat accumulator is arranged in a recess of the isolation plate.

5. The fuel cell system according to claim 1, wherein thermal energy generated during operation by an energy conversion process taking place in the multiple individual fuel cells is, after a shutdown of the fuel cell stack and after the fuel cell stack has cooled down, releasable from the heat accumulator to the current collector upon a subsequent start for purposes of accelerated heating of the current collector.

6. The fuel cell system according to claim 3, wherein thermal energy generated during operation by an energy conversion process taking place in the multiple individual fuel cells is, after a shutdown of the fuel cell stack and after the fuel cell stack has cooled down, releasable from the heat accumulator to the current collector upon a subsequent start for purposes of accelerated heating of the current collector.

7. The fuel cell system according to claim 4, wherein thermal energy generated during operation by an energy conversion process taking place in the multiple individual fuel cells is, after a shutdown of the fuel cell stack and after the fuel cell stack has cooled down, releasable from the heat accumulator to the current collector upon a subsequent start for purposes of accelerated heating of the current collector.

8. The fuel cell system according to claim 1, further comprising a compensation reservoir for accommodating a change in volume of the heat accumulator.

9. The fuel cell system according to claim 3, further comprising a compensation reservoir for accommodating a change in volume of the heat accumulator.

10. The fuel cell system according to claim 4, further comprising a compensation reservoir for accommodating a change in volume of the heat accumulator.

11. The fuel cell system according to claim 8, wherein the compensation reservoir is formed by a fibrous or foamed structure situated in intermediate spaces of the heat accumulator.

12. The fuel cell system according to claim 1, wherein the heat accumulator comprises a material present in a metastable state in a suitable temperature range, said material being caused by a triggering mechanism to crystallize.

13. The fuel cell system according to claim 12, wherein the material comprises salt hydrates, paraffins, or sugar alcohols.

14. The fuel cell system according to claim 1, wherein the heat accumulator is a latent heat accumulator, a thermochemical accumulator or a sorption accumulator.

15. The fuel cell system according to claim 12, wherein the triggering mechanism for the release of heat from the heat accumulator comprises a cold supply or ultrasound.

16. The fuel cell system according to claim 15, wherein the cold supply is provided by way of a cold finger, a Peltier element, or a clicker.

17. The fuel cell system according to claim 1, wherein sub-units of heat accumulators are provided on the current collector.

18. The fuel cell system according to claim 1, further comprising an additional heat source provided on the current collector in addition to the heat accumulator.

19. A motor vehicle, comprising:
a fuel cell system, comprising:
multiple individual fuel cells combined to form a fuel cell stack;
two current collectors, each of which adjoins a respective end-side one of the individual fuel cells;
two end plates, each end plate adjoining a respective current collector; and
a heat accumulator provided on at least one of the current collectors so as to adjoin a side of the one current collector which faces away from the individual fuel cell.

20. The motor vehicle according to claim 19, further comprising:
isolation plates, each isolation plate being interposed between a respective current collector and the end plate.
